(19) United States
(12) Patent Application Publication
(10) Pub. No.: US 2016/0059707 A1
(43) Pub. Date: Mar. 3, 2016

(54) METHOD AND APPARATUS FOR CONTROLLING ELECTRICAL CURRENTS IN A VEHICLE

(71) Applicant: General Electric Company, Schenectady, NY (US)

(72) Inventors: James Thomas Peters, III, Lawrence Park, PA (US); Jean Pierre Karenzi, Erie, PA (US); Sudhir Kumar Gupta, Erie, PA (US)

(73) Assignee: GENERAL ELECTRIC COMPANY, Schenectady, NY (US)

(21) Appl. No.: 14/476,102

(22) Filed: Sep. 3, 2014

(51) Int. Cl. B60L 11/02; F16C 41/00; B61F 15/20

(52) U.S. Cl. CPC B60L 11/02; B61F 15/20; F16C 41/002

(57) ABSTRACT

An embodiment of the present invention relates to an apparatus. The apparatus includes a head portion, a body portion having a distal end opposite the head portion, a brush extending from the distal end of the body portion. The brush is configured to electrically contact an axle shaft of a vehicle.

### FIELD OF THE INVENTION

Embodiments of the invention relate generally to vehicles. Other embodiments relate to a method and apparatus for controlling electrical currents in a rail vehicle.

### BACKGROUND OF THE INVENTION

In the rail industry, rail vehicles are utilized to transport passengers and/or cargo from location to location on a track. A typical rail vehicle, such as a diesel electric locomotive, is propelled by exerting torque to drive wheels associated with the locomotive that are in contact with rails of the track. The power to propel the locomotive is typically provided first as mechanical energy by a high horsepower diesel engine. The diesel engine drives a generator that converts the mechanical energy to electrical energy. The electrical energy is transferred to traction motors which convert the electrical energy back to mechanical energy in order to drive axles connected to the drive wheels. Friction between the drive wheels of the locomotive and the rails provide the traction for causing movement of the locomotive and the railway cars.

On vehicles with axle mounted motors driven by variable frequency drives (converters), currents can flow through the axle bearings due to various reasons. These currents are capable of causing electrical discharges in the bearings, which may result in pitting on the bearing races. Over time, these pittings, along with the vibrations due to travel along the track, may cause characteristic patterns on the bearing races known as “fluting,” which may result in decreased service life requiring early maintenance.

In view of the above, there is a need for a method and apparatus to control the electrical currents in a vehicle to decrease the likelihood of fluting in the axle bearings of the vehicle.

### BRIEF DESCRIPTION OF THE INVENTION

An embodiment of the present invention relates to an apparatus. The apparatus includes a head portion, a body portion having a distal end opposite the head portion, and a brush extending from the distal end of the body portion and being configured to electrically contact an axle shaft of a vehicle.

According to another embodiment of the present invention, a method for controlling electrical currents is provided. The method includes the steps of inserting a grounding device into an aperture in a motor suspension unit of a vehicle, and securing the grounding device to the motor suspension unit such that the grounding device contacts a rotating axle shaft of the vehicle, and such that an electrical contact is created between the rotating axle shaft and the motor suspension unit.

According to another embodiment of the present invention, a vehicle is provided. The vehicle includes a plurality of wheels, an axle mounted to the plurality of wheels and a motor suspension unit encompassing the axle. The motor suspension unit is configured to support a motor of the vehicle adjacent to the axle and has at least one aperture formed therein. The vehicle also includes a plurality of bearings positioned within the motor suspension unit and supporting the axle for rotation within motor suspension unit, and a grounding device received in the aperture and contacting the axle. The grounding device creates an electrical contact between the axle and the motor suspension unit and is configured to shunt electrical current away from the bearings of the motor suspension unit.

### BRIEF DESCRIPTION OF THE DRAWINGS

The present invention will be better understood from reading the following description of non-limiting embodiments, with reference to the attached drawings, wherein below:

FIG. 1 is a perspective view of an exemplary rail vehicle.

FIG. 2 is an enlarged, detail view of a traction motor frame and motor suspension unit of the rail vehicle of FIG. 1.

FIG. 3 is an enlarged, detail view of the motor suspension unit of FIG. 2.

FIG. 4 is a detail view of an apparatus for controlling electrical currents in a rail vehicle, according to an embodiment of the present invention.

FIG. 5 is a cross-sectional, front elevational view of a portion of a rail vehicle illustrating the location of installation of the apparatus of FIG. 4.

FIG. 6 is an enlarged, detail view of the apparatus of FIG. 4 installed in a rail vehicle.

FIG. 7 is a common mode voltage diagram for an exemplary rail vehicle in which the apparatus of FIG. 5 is installed.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts. Although exemplary embodiments of the present invention are described with respect to locomotives, or other rail vehicles that travel along a rail or track, embodiments of the invention may also be applicable for use with vehicles and machinery generally, such as, for example, off-highway vehicles.

As used herein, “electrical contact,” “electrical communication” and “electrically coupled” means that the referenced elements are directly or indirectly connected such that an electrical current may flow from one to the other. The connection may include a direct conductive connection (i.e., without an intervening capacitive, inductive or active element), an inductive connection, a capacitive connection, and/or any other suitable electrical connection. Intervening components may be present.

Embodiments of the present invention relate to an apparatus. The apparatus includes a head portion, a body portion having a distal end opposite the head portion, and a brush extending from the distal end of the body portion and being configured to electrically contact an axle shaft of a vehicle.

Other embodiments relate to method for controlling electrical currents in a vehicle. The method includes the steps of inserting a grounding device into an aperture in a motor suspension unit of a vehicle, and securing the grounding device to the motor suspension unit such that the grounding device contacts a rotating axle shaft of the vehicle, and such that an electrical contact is created between the rotating axle shaft and the motor suspension unit.

Yet other embodiments relate to a vehicle. The vehicle includes a plurality of wheels, an axle mounted to the plurality of wheels and a motor suspension unit encompassing the axle. The motor suspension unit is configured to support a motor of the vehicle adjacent to the axle and has at least one aperture formed therein. The vehicle also includes a plurality of bearings positioned within the motor suspension unit and supporting the axle for rotation within motor suspension unit, and a grounding device received in the aperture and contacting the axle. The grounding device creates an electrical contact between the axle and the motor suspension unit and is configured to shunt electrical current away from the bearings of the motor suspension unit.

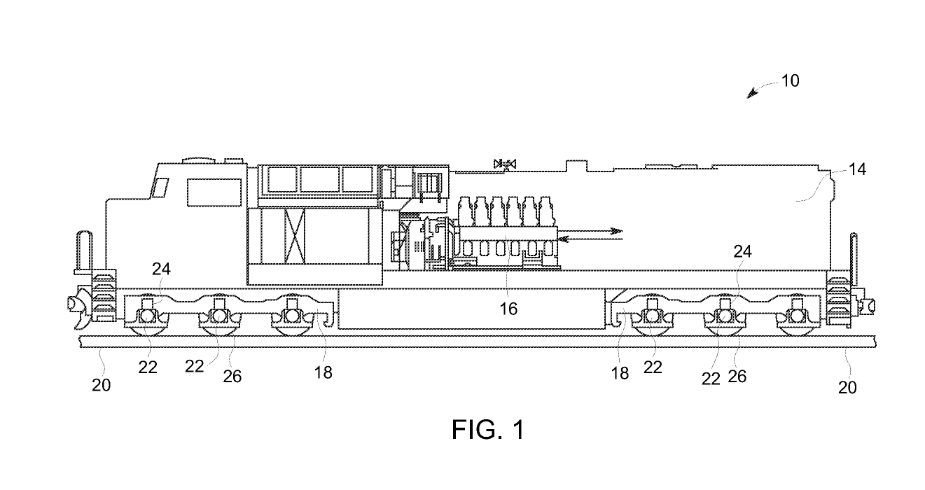

With reference to FIG. 1, an exemplary rail vehicle, such as locomotive 10, that includes the apparatus for controlling electrical currents in a vehicle, includes a car body 14 that houses an engine 16 and other components of the vehicle. The weight of the car body 14 (and the components housed therein) is supported at either end by trucks 18 that transfer the weight to opposing rails 20. The trucks 18 typically include cast or fabricated steel frames that provide a mounting for axles 22, traction motors 24 and wheel sets 26 which provide tractive power to propel and retard motion of the rail vehicle 10. In particular, the engine 16 may drive a three-phase generator (not shown). AC voltage produced by the generator is rectified by a diode array (not shown) which delivers DC voltage to a capacitor and power inverter (not shown). The inverter then delivers three-phase electrical power to the traction motors 24 which provide tractive power to the rail vehicle 10.

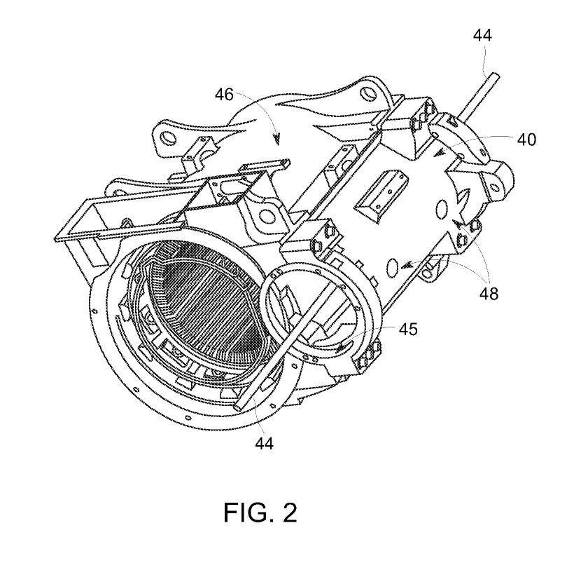

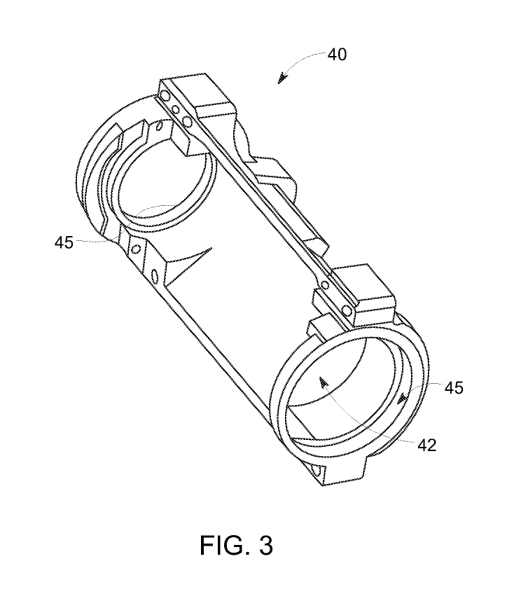

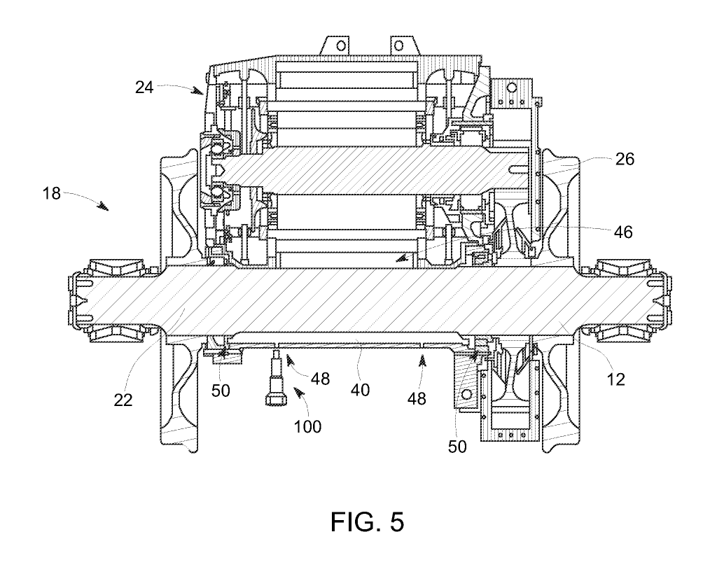

With reference to FIGS. 2 and 3, a rail vehicle may utilize a motor suspension unit 40, also known as a U-Tube, to mount the traction motors 24 to the axle 22 of the vehicle. The motor suspension unit 40 includes a substantially cylindrical opening 42 defining an axle axis 44. An axle shaft 22 of the vehicle is received through the cylindrical opening 42 of the motor suspension unit 40 and is supported for rotation therein by motor suspension unit bearings (illustrated as bearings 50 in FIG. 5) that are positioned in races or recesses 45 in the motor suspension unit 40. A motor housing or motor frame 46 (which houses one of the traction motors 24) is mounted to motor suspension unit 40 via bolts or other suitable fasteners in order to mount the traction motor 24 to the axle 22. As best shown in FIG. 2, the motor suspension unit 40 also includes a plurality of throughbores 48 that extend through an outer wall of the suspension unit 40 to the opening 42. In an embodiment, the throughbores 48 are threaded for mating with a corresponding threaded portion of a bolt. These throughbores 48 are initially used as a point of lifting during assembly, but may also serve as a mounting point for the grounding device of the present invention, as discussed in detail hereinafter.

As will be readily appreciated, operating AC machines such as the traction motors 24 under a variable frequency drive generates non-zero sum of the 3-phase voltages of high rate of voltage change in the motors. With the motor mounting arrangement described in connection with FIGS. 2 and 3, a capacitive coupling exists between the motor windings and motor frame 46, which contacts the motor suspension unit 40, as shown in FIG. 2. This capacitance allows common mode current to pass from the motor winding to the motor frame 46 and motor suspension unit 46. Compared to the motor frame 46 and motor suspension unit, the wheel axle shaft is at lower electric potential. Motor suspension bearings, which are situated between the motor suspension unit 40 and the axle shaft, form a capacitive impedance. Through the capacitive impedance, high dv/dt common mode voltage discharges and current flows through the motor suspension unit bearings which, coupled with vibrations, may cause fluting in the bearings, reducing their service life.

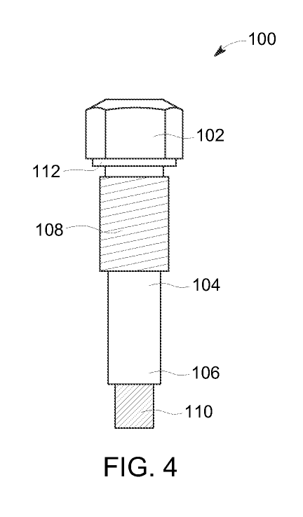

Turning now to FIG. 4, a “grounding device” 100, i.e., a device for controlling electrical currents in a rail vehicle, is illustrated. In the depicted embodiment, the grounding device 100 includes a head portion 102, a body portion 104 attached to (e.g., integrally formed with) the head portion 102, and a distal end 106 opposite the head portion 102. At least a portion of the body portion 104 is formed with a plurality of threads 108 configured to threadingly engage the threads of throughbores 48 in the motor suspension unit 40 in the manner discussed below. As will be readily appreciated, the head portion 102, body portion and distal end 106 may take the form of a bolt. As shown in FIG. 4, the apparatus 100 also includes a brush 110 mounted to distal end 106. In an embodiment, the apparatus 100 may include one or more washers 112 received on the body portion 104 between the head and the threads 108.

In an embodiment, the brush 110 may be a spring-loaded solid brush. The spring-loaded brush includes a brush/bristle block and a spring that biases the brush in an axial direction away from the distal end of the brush such that, in the absence of an axial force on the brush 110 in a direction towards the head portion 102 of the apparatus 100, the brush extends from the distal end 106. As used herein, “axial direction” means a direction along an axis of the apparatus 100 extending through the apparatus 100 from the head portion 102 to the distal end 106. In another embodiment, the brush 110 may be a fiber brush, wherein the brush 110 is statically mounted to the distal end 106 of the apparatus 100. In either embodiment, the fibers (in the case of a fiber brush) and the body of the brush (in the case of a solid brush) are made from a conductive material such as, for example, steel, carbon graphite or copper graphite.

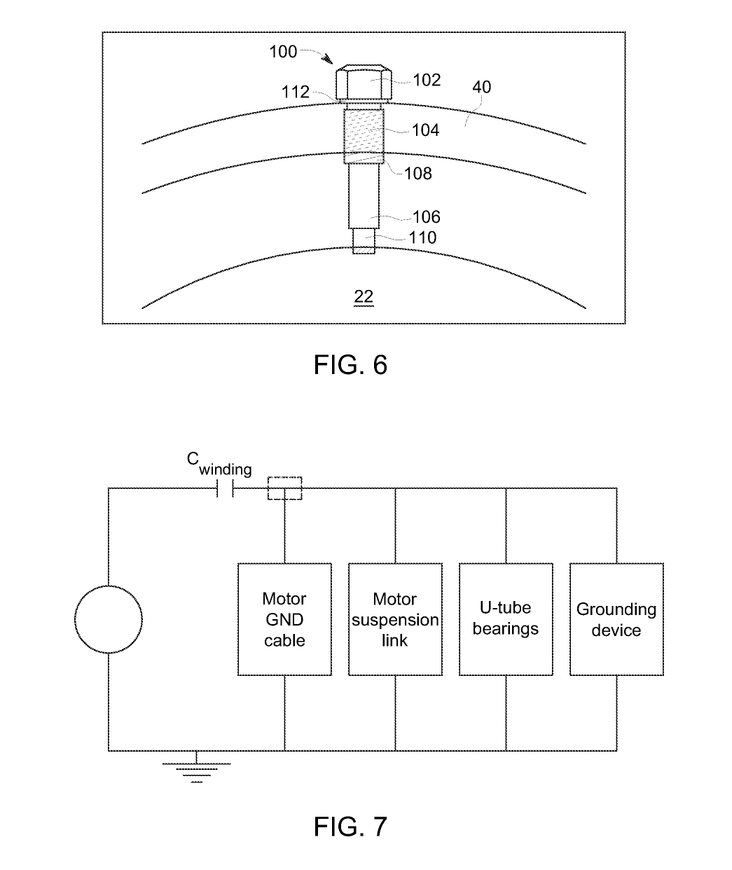

With reference to FIGS. 5 and 6, the apparatus 100 is configured to be installed in the throughbores 48 of the motor suspension unit 40, which are originally used for lifting. In particular, after the motor suspension unit is lifted and installed on a vehicle, one or more apparatuses 100 of the present invention may be respectively installed in one or more of the throughbores 48. In particular, once the truck 18 of the vehicle is outfitted with the axle shaft 22, wheels 26, the motor suspension unit 40, motor suspension unit bearings 50, and traction motor(s) 24, the apparatus 100 is inserted into throughbore 48. As best shown in FIG. 6, in an embodiment, the apparatus 100 is inserted into the throughbore 48 in the motor suspension unit 40 until it contacts the rotating axle shaft 22 housed within the motor suspension unit 40. This arrangement establishes electrical contact between the rotating shaft 22 and the motor suspension unit 40 and functions to shunt electric current across the motor suspension unit bearings 50 to mitigate fluting in the hearings 50. As a result, bearing life may be increased.

As will be readily appreciated, as the brush 110 on the distal end of the apparatus 100 wears, one or more washers 112 may be removed in order to maintain contact between the brush 110 and the axle shaft 22. That is, by removing a washer 112 and re-installing the apparatus 100 in aperture 48, the distal end 116 of the apparatus 100 extends closer to the axle shaft 22, thereby once again brining the brush 110 into touching and electrical contact with the axle shaft 22 despite the wear on the brush 110. In the case of a spring-loaded brush, the bias of the spring automatically biases the brush 110 towards the axle shaft 22 as the brush 110 wears. With a spring-loaded brush, therefore, there is no need to adjust the apparatus or remove any washers in order to maintain electrical contact between the brush 110 and the axle shaft 22.

As shown in FIG. 7, besides the motor suspension unit bearings, common mode current can flow through other paths such as the motor ground cable or the motor suspension link in order to return to the inverter ground. The motor ground cable and motor suspension link, however, present higher impedances compared to the motor suspension unit bearings 50, which causes the common mode current to low through the bearings 50, causing fluting. Utilization of the apparatus 100 of the present invention, however, provides a least impedance path to the inverter ground for the common mode current to flow. Therefore, instead of the bearings 50 of the motor suspension unit, the apparatus 100 of the present invention, when installed in the apertures 48 in the motor suspension unit 40 such that the brush 110 contacts the rotating axle shaft 22 to establish electrical contact between the shaft and the motor suspension unit 40, becomes the preferred path for common mode current to flow. Accordingly, this shunting minimizes the current through the bearings, and therefore mitigates fluting in the bearings 50 of the motor suspension unit 40, thereby leading to increased bearing life.

As will be readily appreciated, the apparatus 100 for controlling electrical currents of the present invention therefore provides a number of technical and commercial advantages. The apparatus 100 may be easily installed in existing apertures in the motor suspension unit that are originally used for lifting during truck assembly and secured in place using a wrench. In connection with this, the apparatus is easily serviceable; the apparatus is easy to install or uninstall without requiring motor suspension unit disassembly. As will be appreciated, however, embodiments of the invention are not limited to utilizing existing apertures or apertures that are configured for use as lifting points.

Moreover, by extending the life of the bearings of motor suspension unit by decreasing the likelihood of fluting due to common mode current flows through the bearings, the overhaul interval for the bearings can be brought into line with the overhaul interval for the wheels of the vehicle. As a result, the vehicle does not have to be taken out of service to replace the bearings prior to scheduled wheel service or replacement. In an embodiment, the apparatus 100 of the present invention helps extend the life of the bearings of the motor suspension unit to at least as long as a scheduled wheel change interval. Further, less frequent replacement of the bearings leads to increased productivity and, therefore, overall cost savings.

In addition to the above, the apparatus 100 of the present invention may be easily retrofit onto existing rail vehicles. In particular, the apparatus 100 of the present invention is not limited to use with a particular AC locomotive motor suspension unit, but can be used in connection with motor suspension units of any existing or new AC locomotive or vehicle with suspended traction motors, as no special modifications or tools are required.

As will be readily appreciated, the apparatus 100 for controlling electrical currents of the present invention is low cost compared to existing methods and devices for addressing fluting issues in motor suspension unit bearings, and is quick and easy to install.

An embodiment of the present invention relates to an apparatus. The apparatus includes a head portion, a body portion having a distal end opposite the head portion, and a brush extending from the distal end of the body portion and being configured to electrically contact an axle shaft of a vehicle.

In an embodiment, the apparatus includes a plurality of threads formed on the body portion. The threads may be configured to engage the inner walls of a throughbore in a motor suspension unit of the vehicle to secure the apparatus to the motor suspension unit.

In an embodiment, the apparatus is configured to establish electrical contact between the axle shaft and the motor suspension unit.

In an embodiment, the apparatus includes at least one washer disposed about the body portion and positioned adjacent to the head portion.

In an embodiment, the brush is a fiber brush having a plurality of conductive fibers. The conductive fibers may be formed from one or more of steel, carbon graphite and copper graphite.

In an embodiment, the brush is spring-biased in an axial direction away from the head portion.

According to another embodiment of the present invention, a method for controlling electrical currents in a vehicle is provided. The method includes the steps of inserting a grounding device into an aperture in a motor suspension unit of a vehicle, and securing the grounding device to the motor suspension unit such that the grounding device contacts a rotating axle shaft of the vehicle, and such that an electrical contact is created between the rotating axle shaft and the motor suspension unit.

In an embodiment, the method also includes the step of shunting electrical current across bearings of the motor suspension unit to mitigate fluting in the bearings.

In an embodiment, the grounding device includes a head portion, a body portion having a distal end opposite the head portion, and a brush extending from the distal end of the body portion. The step of securing the grounding device to the motor suspension unit may include positioning the brush such that it contacts the axle shaft of the vehicle.

In an embodiment, the grounding device includes a plurality of washers disposed about the body portion and positioned adjacent to the head portion. In an embodiment, the method may include also the steps of, when the brush does not contact the axle shaft of the vehicle, removing the grounding device from the motor suspension unit, removing at least one washer from the grounding device, and re-securing the grounding device to the motor suspension unit such that the brush contacts the axle shaft.

In an embodiment, the method may also include the step of lifting the motor suspension unit via the aperture during assembly of the vehicle, prior to inserting the grounding device into the aperture.

According to another embodiment of the present invention, a vehicle is provided. The vehicle includes a plurality of wheels, an axle mounted to the plurality of wheels and a motor suspension unit encompassing the axle. The motor suspension unit is configured to support a motor of the vehicle relative to the axle (e.g., adjacent to the axle) and has at least one aperture formed therein. The vehicle also includes a plurality of bearings positioned within the motor suspension unit and supporting the axle for rotation within motor suspension unit, and a grounding device received in the aperture and contacting the axle. The grounding device creates an electrical contact between the axle and the motor suspension unit and is configured to shunt electrical current away from the bearings of the motor suspension unit.

In an embodiment, the aperture is an existing aperture in the motor suspension unit that serves as a lifting point during assembly of the vehicle.

In an embodiment, the grounding device includes a head portion, a body portion having a distal end opposite the head portion, and a brush extending from the distal end of the body portion and being configured to electrically contact the axle of the vehicle.

In an embodiment, the brush is a fiber brush having a plurality of conductive fibers. In an embodiment, the conductive fibers are formed from one or more of steel, carbon graphite and copper graphite.

In an embodiment, the brush is spring-biased in an axial direction away from the head portion.

In an embodiment, the grounding device further includes a plurality of threads formed on the body portion. The threads are configured to engage the inner wall of the at least one aperture in the motor suspension unit to secure the grounding device to the motor suspension unit.

In an embodiment, the grounding device further includes at least one washer disposed about the body portion and positioned adjacent to the head portion.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The terms “including” and “in which” are used as the plain-English equivalents of the respective terms “comprising” and “wherein.” Moreover, the terms “first,” “second,” “third,” “upper,” “lower,” “bottom,” “top,” etc. are used merely as labels, and are not intended to impose numerical or positional requirements on their objects.

This written description uses examples to disclose several embodiments of the invention, including the best mode, and also to enable one of ordinary skill in the art to practice the embodiments of invention, including making and using any devices or systems and performing any incorporated methods.

As used herein, an element or step recited in the singular and proceeded with the word “a” or “an” should be understood as not excluding plural of the elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including.” or “having” an element or a plurality of elements having a particular property may include additional such elements not having that property.

Since certain changes may be made in the embodiments described herein without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An apparatus, comprising:
a head portion;
a body portion having a distal end opposite the head portion; and
a brush extending from the distal end of the body portion and being configured to electrically contact an axle shaft of a vehicle.

2. The apparatus of claim 1, further comprising:
a plurality of threads formed on the body portion, the threads being configured to engage an inner wall of a throughbore in a motor suspension unit of the vehicle to secure the apparatus to the motor suspension unit.

3. The apparatus of claim 2, wherein:
the apparatus is configured to establish electrical contact between the axle shaft and the motor suspension unit.

4. The apparatus of claim 1, further comprising:
at least one washer disposed about the body portion and positioned adjacent to the head portion.

5. The apparatus of claim 1, wherein:
the brush is a fiber brush having a plurality of conductive fibers.

6. The apparatus of claim 5, wherein:
the conductive fibers are formed from one or more of steel, carbon graphite, or copper graphite.

7. The apparatus of claim 1, wherein:
the brush is spring-biased in an axial direction away from the head portion.

8. A method for controlling electrical currents, comprising the steps of:
inserting a grounding device into an aperture in a motor suspension unit of a vehicle; and
securing the grounding device to the motor suspension unit such that the grounding device contacts a rotating axle shaft of the vehicle such that an electrical contact is created between the rotating axle shaft and the motor suspension unit.

9. The method according to claim 8, further comprising the step of:
shunting electrical current across bearings of the motor suspension unit to mitigate fluting in the bearings.

10. The method according to claim 8, wherein:
the grounding device includes a head portion, a body portion having a distal end opposite the head portion, and a brush extending from the distal end of the body portion;
wherein securing the grounding device to the motor suspension unit includes positioning the brush such that it contacts the axle shaft of the vehicle.

11. The method according to claim 10, wherein:
the grounding device further includes a plurality of washers disposed about the body portion and positioned adjacent to the head portion, and wherein the method further includes the steps of:
when the brush does not contact the axle shaft of the vehicle, removing the grounding device from the motor suspension unit;
removing at least one of the plurality of washers from the grounding device; and
re-securing the grounding device to the motor suspension unit such that the brush contacts the axle shaft.

12. The method according to claim 8, further comprising the step of:
lifting the motor suspension unit via the aperture during assembly of the vehicle, prior to inserting the grounding device into the aperture.

13. A vehicle, comprising:
a plurality of wheels;
an axle mounted to the plurality of wheels;
a motor suspension unit configured to support a motor of the vehicle relative to the axle, the motor suspension unit having an aperture formed therein;
a plurality of bearings positioned within the motor suspension unit and supporting the axle for rotation within motor suspension unit; and
a grounding device received in the aperture and contacting the axle, the grounding device creating an electrical contact between the axle and the motor suspension unit and being configured to shunt electrical current away from the bearings of the motor suspension unit.

14. The vehicle of claim 13, wherein:
the aperture is an existing aperture in the motor suspension unit that serves as a lifting point during assembly of the vehicle.

15. The vehicle of claim 13, wherein:
the grounding device includes a head portion, a body portion having a distal end opposite the head portion, and a brush extending from the distal end of the body portion and being configured to electrically contact the axle of the vehicle.

16. The vehicle of claim 15, wherein:
the brush is a fiber brush having a plurality of conductive fibers.

17. The vehicle of claim 16, wherein:
the conductive fibers are formed from one or more of steel, carbon graphite, or copper graphite.

18. The vehicle of claim 15, wherein:
the brush is spring-biased in an axial direction away from the head portion.

19. The vehicle of claim 15, wherein:
the grounding device further includes a plurality of threads formed on the body portion, the threads being configured to engage an inner wall of the aperture in the motor suspension unit to secure the grounding device to the motor suspension unit.

20. The vehicle of claim 15, wherein:
the grounding device further includes at least one washer disposed about the body portion and positioned adjacent to the head portion.
